(19) United States
(12) Patent Application Publication
(10) Pub. No.: US 2025/0296314 A1
(43) Pub. Date: Sep. 25, 2025

(54) APPARATUS AND METHOD FOR MANUFACTURING DISPLAY DEVICE

(71) Applicant: Samsung Display Co., LTD., Yongin-si (KR)

(72) Inventors: Yong Hwan YOON, Yongin-si (KR); Kwan Bae KONG, Yongin-si (KR); Jong Suk LEE, Yongin-si (KR); So Hyun KIM, Yongin-si (KR); Ji Hoon SONG, Yongin-si (KR)

(21) Appl. No.: 18/921,954

(22) Filed: Oct. 21, 2024

(30) Foreign Application Priority Data
Mar. 20, 2024 (KR) 10-2024-0038234

(51) Int. Cl. B32B 41/00; B32B 37/10; B32B 37/18

(52) U.S. Cl. CPC B32B 41/00; B32B 37/10; B32B 37/18; B32B 2041/04; B32B 2457/20

(57) ABSTRACT

An apparatus for manufacturing a display device includes: a pressing pad including a first fixing portion and a pressing portion on the first fixing portion. The pressing portion includes: a first surface on an opposite side with respect to the first fixing portion; a second surface between the first surface and the first fixing portion; and a third surface extending between the first surface and the second surface. The second surface is a circular curved surface that is inwardly depressed.

### CROSS-REFERENCE TO RELATED APPLICATION

The present application claims priority to and the benefit of Korean Patent Application No. 10-2024-0038234, filed on Mar. 20, 2024, in the Korean Intellectual Property Office, the entire content of which is incorporated herein by reference.

### BACKGROUND

### 1. Field

Aspects of embodiments of the present disclosure relate to an apparatus and method for manufacturing a display device.

### 2. Description of Related Art

As an information society develops, the demand for display devices for displaying an image in various forms is increasing. Display devices may be displays, such as liquid crystal displays (LCDs), field emission displays (FEDs), or light emitting displays (LEDs). The light emitting display may include an organic light emitting display device including an organic light emitting diode element as a light emitting element or an inorganic light emitting display device including an inorganic light emitting diode element as a light emitting element.

The display device may include a display panel and a cover window for protecting the display panel. The display panel may include a driving element, a light emitting element, etc. The cover window may be attached to at least one surface of the display panel. In this case, when pressing the display panel using a pressing pad, the display panel and the cover window may be bonded together.

### SUMMARY

Embodiments of the present disclosure provide an apparatus and method for manufacturing a display device that reduces or minimizes an occurrence of bubbles between a cover window and a display panel during a process of bonding the cover window and the display panel.

Embodiments of the present disclosure also provide an apparatus and method for manufacturing a display device that reduces or minimizes damage to the display device during a process of bonding a cover window and a display panel. However, aspects and features of the present disclosure are not limited to those set forth herein. The above and other aspects and features of the present disclosure will become more apparent to one of ordinary skill in the art to which the present disclosure pertains by referencing the detailed description of the present disclosure given below.

According to an embodiment of the present disclosure, an apparatus for manufacturing a display device includes: a pressing pad including a first fixing portion and a pressing portion on the first fixing portion. The pressing portion includes: a first surface on an opposite side with respect to the first fixing portion; a second surface between the first surface and the first fixing portion; and a third surface extending between the first surface and the second surface. The second surface is a circular curved surface that is inwardly depressed.

The second surface may be an outwardly convex circular curved surface.

The pressing pad may be configured to bond a display panel and a cover window, and a radius of curvature of the first surface may be smaller than a radius of curvature of an inner side surface of the cover window.

The radius of curvature of the first surface may be 0.5 times or more than the radius of curvature of an inner side surface of the cover window.

The cover window may have a three-dimensional shape with curved edges in a cross-sectional view.

The third surface may be an outwardly convex circular curved surface.

The pressing portion may have: the first surface has an arc that is part of a first circle; the second surface has an arc that is part of a second circle; and the third surface has an arc that is part of a third circle. The third circle may be in contact with each of the first circle and the second circle.

The third circle may be inscribed in the first circle and circumscribed about the second circle.

The first surface, the second surface, and the third surface may each have a single radius of curvature.

The first surface may have a first radius of curvature, the second surface may have a second radius of curvature, and the third surface may have a third radius of curvature. The first radius of curvature may be greater than the second radius of curvature, and the second radius of curvature may be greater than the third radius of curvature.

The apparatus may further include a stage configured to provide a space at where the pressing is seated. The stage may include a second fixing portion configured to be coupled to the first fixing portion.

According to another embodiment of the present disclosure, an apparatus for manufacturing a display device includes: a pressing pad including a first fixing portion and a pressing portion on the first fixing portion; and an alignment portion protruding on the first fixing portion. The alignment portion protrudes further than an outer portion of the first fixing portion and an outer portion of the pressing pad in a plan view.

The pressing pad may be configured to bond a display panel and a cover window, and the alignment portion may protrudes further than an outer portion of the display panel in the plan view.

The alignment portion may include a first portion protruding further than the outer portion of the display panel in the plan view and a second portion covered by the display panel.

According to another embodiment of the present disclosure, a method for manufacturing a display device by using an apparatus for manufacturing a display device is provided. The apparatus includes: a pressing pad including a first fixing portion and a pressing portion on the first fixing portion, an alignment portion protruding on the first fixing portion, and a stage forming a space at where the pressing pad is seated. The method includes: aligning a display panel and a cover window on the apparatus; and pressing the display panel and the cover window with the pressing pad.

In the aligning of the display panel and the cover window, the pressing pad, the display panel, and the cover window may be stacked in that order.

The apparatus may further include a vision device on the cover window. The alignment portion may protrude further than an outer portion of the display panel, and the vision device may be configured to recognize the protruding portion of the alignment portion.

The vision device may be configured to align an intersection of diagonal lines connecting the alignment portions arranged diagonally about a center of the cover window.

The vision device may be configured to align an intersection of perpendicular lines between one alignment portion and a side opposite to the one alignment portion about a center of the cover window.

In the pressing of the display panel and the cover window, the pressing pad may contact the display panel.

The apparatus and method for manufacturing the display device, according embodiments of the present disclosure, reduce or minimize the occurrence of bubbles between the cover window and the display panel during a process of bonding the cover window and the display panel.

The apparatus and method for manufacturing the display device, according embodiments of the present disclosure, reduce or minimize damage to the display device during a process of bonding the cover window and the display panel.

However, aspects and features of the present disclosure are not limited to those set forth herein. The above and other aspects and features of embodiments of the present disclosure will become more apparent to one of ordinary skill in the art to which the embodiments pertain by referencing the claims and the detailed description.

### BRIEF DESCRIPTION OF THE DRAWINGS

The above and other aspects and features of the present disclosure will become more apparent by describing, in detail, embodiments thereof with reference to the attached drawings, in which:

FIG. 1 is a plan view of a display device according to an embodiment;

FIGS. 2 to 3 are cross-sectional views illustrating steps of a method for manufacturing a display device according to an embodiment;

FIG. 4 is a perspective view of an apparatus for manufacturing a display device according to an embodiment;

FIG. 5 is a side view of apparatus for manufacturing a display device as shown in FIG. 4;

FIG. 6 is a cross-sectional view of the apparatus for manufacturing a display device taken along the line X1-X1′ in FIG. 4;

FIG. 7 is an enlarged view of the area A in FIG. 6;

FIG. 8 is a plan view illustrating a process of aligning a cover window, a display panel, and a pressing pad according to an embodiment;

FIG. 9 is a plan view of a pressing pad according to an embodiment;

FIG. 10 is a plan view of a pressing pad according to another embodiment;

FIG. 11 is a plan view of a pressing pad according to another embodiment; and

FIG. 12 is a flowchart describing a method for manufacturing a display device according to an embodiment.

### DETAILED DESCRIPTION

The present disclosure will now be described more fully hereinafter with reference to the accompanying drawings, in which embodiments of the present disclosure are shown. The present disclosure may, however, be embodied in different forms and should not be construed as limited to the embodiments set forth herein. Rather, these embodiments are provided so that this disclosure will be thorough and complete and will fully convey the scope of the invention to those skilled in the art.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

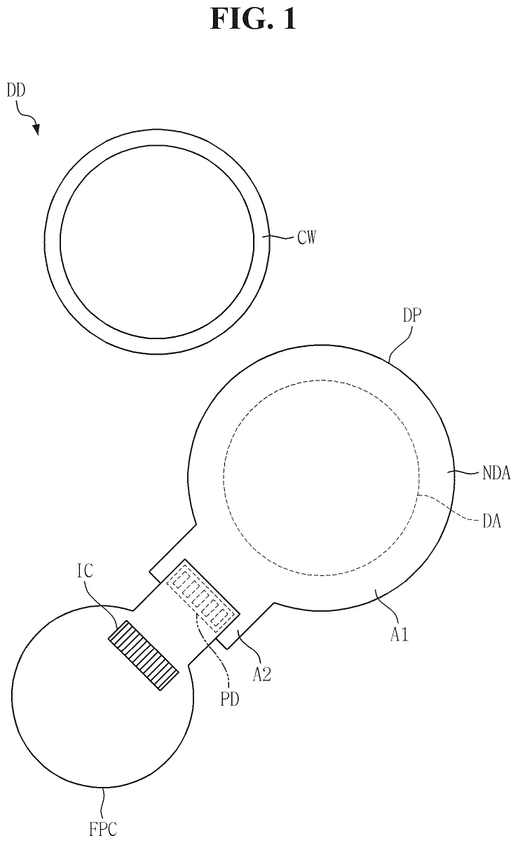

FIG. 1 is a plan view of a display device according to an embodiment.

Referring to FIG. 1, a display device DD may be applied to various electronic devices, such as small and medium-sized electronic equipment, such as tablet PCs, smartphones, car navigation units, cameras, central information displays (CIDs) provided in automobiles, wristwatch-type electronic devices, personal digital assistants (PDAs), portable multimedia players (PMPs), and game machines, and medium and large-sized electronic equipment, such as televisions, external billboards, monitors, personal computers, notebook computers, and the like. For example, FIG. 1 illustrates an embodiment in which the display device DD is applied to a smart watch, but the present disclosure is not limited thereto. These example electronic devices are presented merely as examples, and the display device DD may be employed in other electronic devices as long as they do not deviate from the concept of the present disclosure.

The display device DD may include a display panel DP, a printed circuit board FPC, a driving chip IC, and a cover window CW.

The display panel DP may display an image. The display panel DP may have a display area DA and a non-display area NDA surrounding at least a portion of (e.g., extending around at least a portion of a periphery of) the display area DA. The display area DA may be an area at where an image is displayed. The non-display area NDA may be an area that where no image is displayed.

The non-display area NDA may be divided into a first area A1 surrounding (e.g., extending around a periphery of) the display area DA and a second area A2 protruding from the first area A1. The second area A2 may protrude outwardly from the first area A1 and may have a narrower width than the first area A1, but the present disclosure is not limited thereto.

A connection portion PD may be disposed on one side of the non-display area NDA. A plurality of pads that are electrically connected to various signal lines may be disposed on the connection portion PD.

In an embodiment, the display panel DP may have a circular shape with one side protruding (e.g., one protrusion side) in a plan view. In such an embodiment, the display area DA may have a circular shape in a plan view. However, the configuration of embodiments of the present disclosure is not limited thereto, and the display area DA may have a quadrangular shape, a shape formed by straight lines and curves, etc., in a plan view.

The printed circuit board FPC may be disposed on the display panel DP to overlap the second area A2. The printed circuit board FPC may be electrically connected to the display panel DP through the connection portion PD. The printed circuit board FPC may generate signals to drive the display area DA and may transmit the signals to the display area DA.

In some embodiments, the printed circuit board FPC may be flexible (e.g., may be a flexible printed circuit board). In such an embodiment, the printed circuit board FPC may be bent and folded.

The cover window CW may be disposed on the display panel DP to protect the display panel DP. The cover window CW may transmit light emitted from the display panel DP. In some embodiments, the cover window CW may have a light blocking portion in a bezel area to block some of the light emitted from the display panel DP.

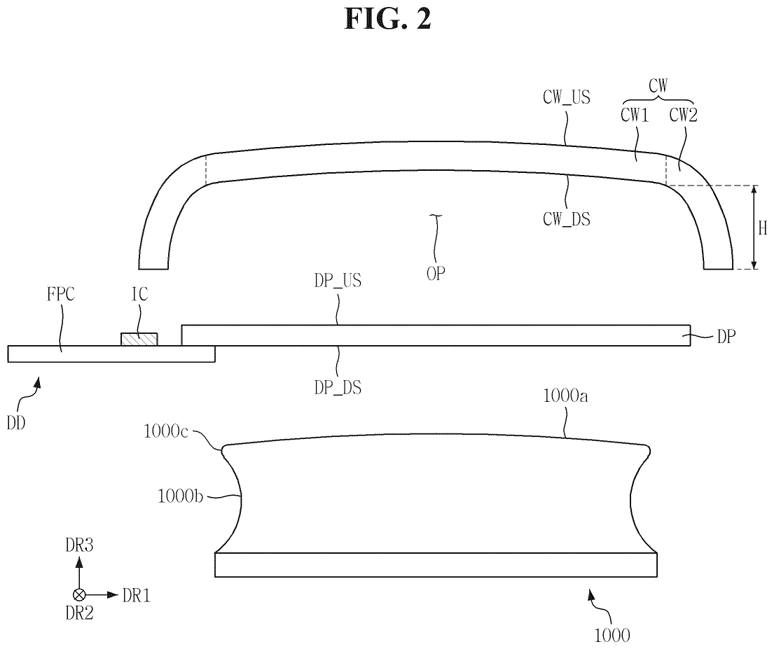

As will be described later with reference to FIG. 2, the cover window CW may be disposed on the front surface of the display panel DP. The cover window CW may be disposed to overlap the display panel DP and may cover the front surface of the display panel DP.

The cover window CW may be made of a transparent plastic material, a glass material, or a tempered glass material. In an embodiment, the cover window CW may be made of any one of sapphire (e.g., Al₂O₃) glass and Gorilla Glass (a registered trademark of Corning Incorporate) (e.g., ion exchange strengthened glass) and/or may have a laminated structure thereof. In another embodiment, the cover window CW may include any one of polyethylene terephthalate (PET), polycarbonate (PC), polyethersulfone (PES), polyethylene naphthalate (PEN), and polynorbornene (PNB). The cover window CW may be made of tempered glass in consideration of its scratch resistance and transparency.

The cover window CW may have a shape corresponding to the shape of the display panel DP. For example, in an embodiment in which the display panel DP has a circular shape in a plan view, the cover window CW may have a circular shape in a plan view.

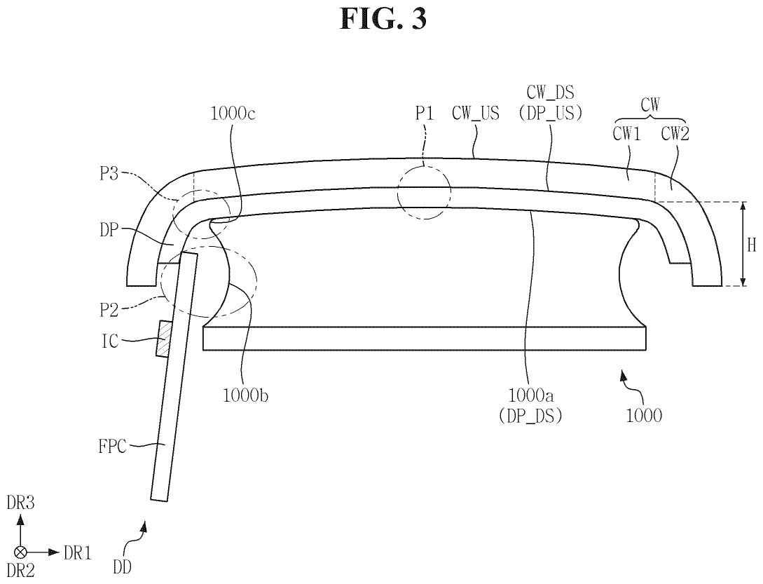

FIGS. 2 to 3 are cross-sectional views illustrating steps of a method for manufacturing a display device according to an embodiment. FIG. 2 is a view illustrating a state before the cover window CW and the display panel DP are bonded, and FIG. 3 is a view illustrating a state after the cover window CW and the display panel DP are bonded.

Referring to FIGS. 2 and 3, the cover window CW may be disposed on the display panel DP. The cover window CW may be disposed to overlap the display panel DP and cover an upper surface DP_UP of the display panel DP.

In some embodiments, the cover window CW may have a three-dimensional shape. The cover window CW may have a shape with curved edges in a cross-sectional view. For example, the cover window CW may have a dome shape, but it is not limited thereto.

The cover window CW may form an accommodating portion OP. The accommodating portion OP may have a depth (e.g., a predetermined depth) H. Accordingly, the cover window CW may accommodate the display panel DP, the driving chip IC, and the printed circuit board FPC.

In some embodiments, the cover window CW may have a shape that protrudes convexly toward a display surface. For example, an upper surface CW_US and a lower surface CW_DS of the cover window CW may each have a convex shape in the third direction DR3. The display surface may be a surface (e.g., an upper surface in the drawing) in a direction in which light emitted from the display panel DP transmits through the cover window CW and exits.

In the drawing, the third direction DR3 may be a vertical direction. For example, the third direction DR3 may be a thickness direction of the display panel DP. The first direction DR1 and the second direction DR2 may be horizontal directions that cross (e.g., intersect) the third direction DR3 and, for example, are orthogonal to the third direction DR3. The first direction DR1 and the second direction DR2, which are each horizontal direction, may cross (e.g., may intersect) each other. For example, the first direction DR1 and the second direction DR2 may be orthogonal to each other. In the present specification, directions indicated by arrows in the first to third directions DR1, DR2, and DR3 may be referred to as one side and the opposite direction thereof may be referred to as the other side. When only the first to third directions DR1, DR2, and DR3 are specified without mentioning one side or the other side, both one side and the other side may be referred to, or at least one of one side or the other side may be referred to.

In some embodiments, the cover window CW may include a first cover portion CW1 and a second cover portion CW2. The first cover portion CW1 may be at the center of the cover window CW. The second cover portion CW2 may be disposed around the first cover portion CW1. For example, the second cover portion CW2 may surround the first cover portion CW1 in a plan view.

The first cover portion CW1 may extend in the horizontal direction in the first direction DR1 and the second direction DR2, and the second cover portion CW2 may extend in the vertical direction in the third direction DR3.

A curvature of the first cover portion CW1 and a curvature of the second cover portion CW2 may be different. For example, based on a boundary (e.g., a boundary surface) between the first cover portion CW1 and the second cover portion CW2, curvatures of the upper surface CW_US and the lower surface CW_DS of the cover window CW in the first cover portion CW1 may be different from curvatures of the upper surface CW_US and the lower surface CW_DS of the cover window CW in the second cover portion CW2.

The apparatus 1000 for manufacturing a display device may bond the display panel DP and the cover window CW. The apparatus 1000 for manufacturing a display device may be a laminating apparatus.

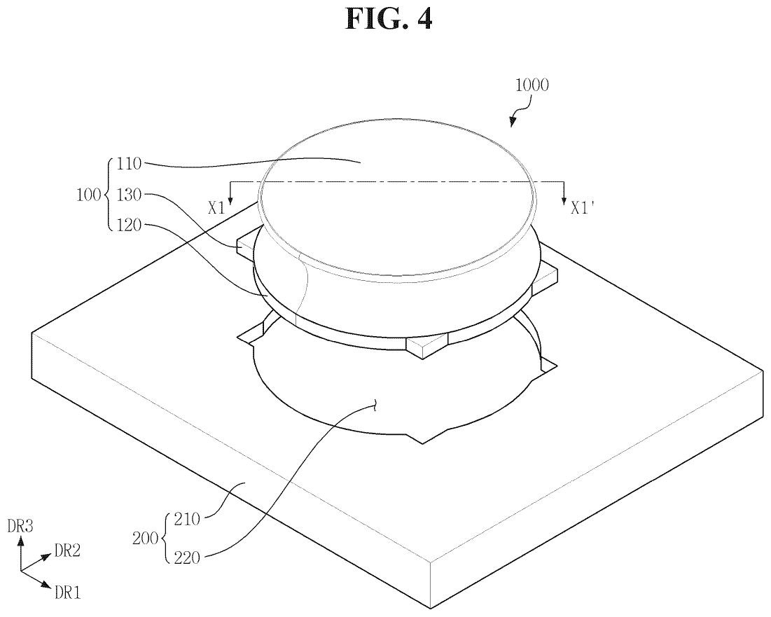

The apparatus 1000 for manufacturing a display device may move in the third direction DR3. The apparatus 1000 for manufacturing a display device may include a pressing pad 100 (see, e.g., FIG. 4). The apparatus 1000 for manufacturing a display device may move in the third direction DR3 to press the lower surface DP_DS of the display panel DP.

Through this, the display panel DP and the cover window CW may be bonded. For example, the upper surface DP_US of the display panel DP may be attached to the lower surface CW_DS of the cover window CW.

In some embodiments, a contact surface in contact with an upper surface 1000a of the apparatus 1000 for manufacturing a display device, for example, the lower surface DP_DS of the display panel DP, may be a curved surface. For example, the upper surface 1000a of the apparatus 1000 for manufacturing a display device may have a shape that is outwardly convex (e.g., in the third direction DR3). The upper surface 1000a of the apparatus 1000 for manufacturing a display device may have a shape that is outwardly convex corresponding to the shape of the upper surface CW_US and lower surface CW_DS of the cover window CW.

When the upper surface CW_US and lower surface CW_DS of the cover window CW are each convex in the third direction DR3 and the upper surface 1000a of the apparatus 1000 for manufacturing a display device is flat, a peripheral portion of P1 may be bonded first instead of being bonded starting from the P1 portion, which is the center of the cover window CW. In this case, bubbles may be formed between the lower surface CW_DS of the cover window CW and the upper surface DP_US of the display panel DP.

Because the upper surface 1000a of the apparatus 1000 for manufacturing a display device according to embodiments of the present embodiment is formed as a curved surface corresponding to the shape of the upper surface CW_US and lower surface CW_DS of the cover window CW, the bonding may be performed from the P1 portion to the peripheral portion, thereby reducing or minimizing bubble formation.

In some embodiments, a side surface 1000b of the apparatus 1000 for manufacturing a display device may be a curved surface. For example, the side surface 1000b of the apparatus 1000 for manufacturing a display device may have an inwardly concave (or depressed) shape.

When the apparatus 1000 for manufacturing a display device presses the display panel DP, the display panel DP and the cover window CW come into close contact so that the display panel DP may be in contact with the cover window CW while at least a portion thereof is bent. For example, through the apparatus 1000 for manufacturing a display device, the display panel DP may be bent to have a curved surface following an inner curved shape of the cover window CW. The apparatus 1000 for manufacturing a display device may expand in the horizontal direction due to the elasticity and pressing force of the pressing pad 100 (see, e.g., FIG. 2).

Because the side surface 1000b of the apparatus 1000 for manufacturing a display device according to embodiments of the present embodiment has an inwardly concave shape, an empty space may be formed between the side surface 1000b of the apparatus 1000 for manufacturing a display device and the printed circuit board FPC. Therefore, even if the apparatus 1000 for manufacturing a display device expands, the printed circuit board FPC may not contact the side surface 1000b of the apparatus 1000 for manufacturing a display device at a P2 portion. Accordingly, the occurrence of cracks and defects in the display device DD may be reduced or minimized.

In some embodiments, a corner surface 1000c disposed between the upper surface 1000a and the side surface 1000b of the apparatus 1000 for manufacturing a display device may be a curved surface. For example, the corner surface 1000c of the apparatus 1000 for manufacturing a display device may have a round curved shape.

As described above, the curvature of the lower surface CW_DS of the cover window CW may be different based on the boundary surface between the first cover portion CW1 and the second cover portion CW2 of the cover window CW. Therefore, stress applied to the display panel DP may be greater near a boundary surface between the first cover portion CW1 and the second cover portion CW2, such as a P3 portion, than in other portions.

Because the corner surface 1000c of the apparatus 1000 for manufacturing a display device according to embodiments of the present embodiment has a round curved shape, the stress applied to the display panel DP at the P3 portion may be reduced or minimized.

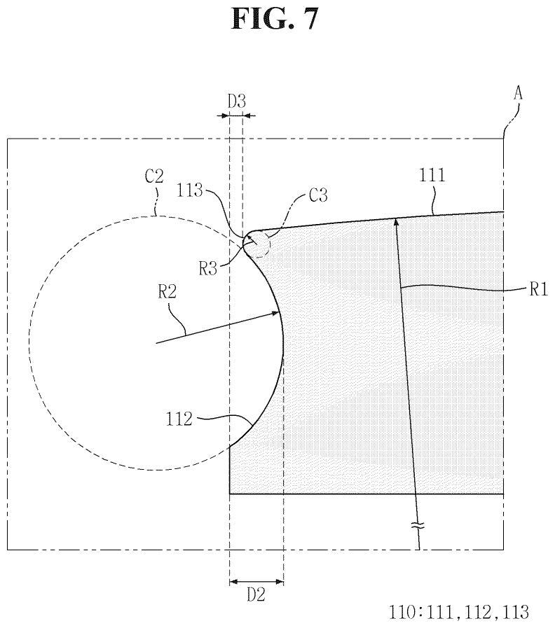

A design methodology of the upper surface 1000a, side surface 1000b, and corner surface 1000c of the apparatus 1000 for manufacturing a display device will be described later with reference to FIG. 7.

Hereinafter, a detailed structure of the apparatus 1000 for manufacturing a display device will be described.

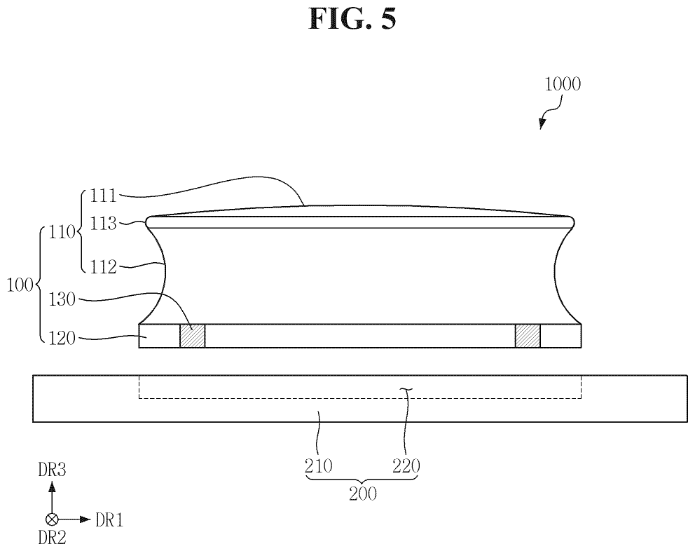

FIG. 4 is a perspective view of an apparatus for manufacturing a display device according to an embodiment. FIG. 5 is a side view of the apparatus for shown in FIG. 4.

Referring to FIGS. 4 and 5, in addition to FIGS. 1 to 3, the apparatus 1000 for manufacturing a display device may include a pressing pad 100 and a stage 200.

The pressing pad 100 may include a pressing portion 110, a first fixing portion 120, and an alignment portion 130.

The pressing portion 110 may be disposed on the first fixing portion 120. The pressing portion 110 may be in direct contact with the display panel DP during the bonding process. The pressing portion 110 may include an elastic material. The pressing portion 110 may include at least one of silicone, urethane, rubber, and synthetic resin. However, the pressing portion 110 is not limited thereto and may include other elastic materials in addition to the materials listed above.

The pressing portion 110 may be deformed in shape by a pressing force during the bonding process. The pressing portion 110 may be restored to an original shape thereof after the bonding is completed due to an elastic force.

In some embodiments, the pressing portion 110 may have an overall uniform density. For example, a mass of an elastic material relative to a unit volume at any point of the pressing portion 110 may be the same as a mass of an elastic material relative to a unit volume at any other point thereof. Accordingly, because the pressing force applied to the display panel DP may be evenly distributed, damage to the display panel DP may be reduced or minimized, and the occurrence of bubbles at the interface between the display panel DP and the cover window CW may be reduced or minimized.

The first fixing portion 120 may be disposed below the pressing portion 110. The first fixing portion 120 may fix the pressing pad 100 to the stage 200. The first fixing portion 120 may be coupled to a second fixing portion 220 of the stage 200 to fix the pressing pad 100.

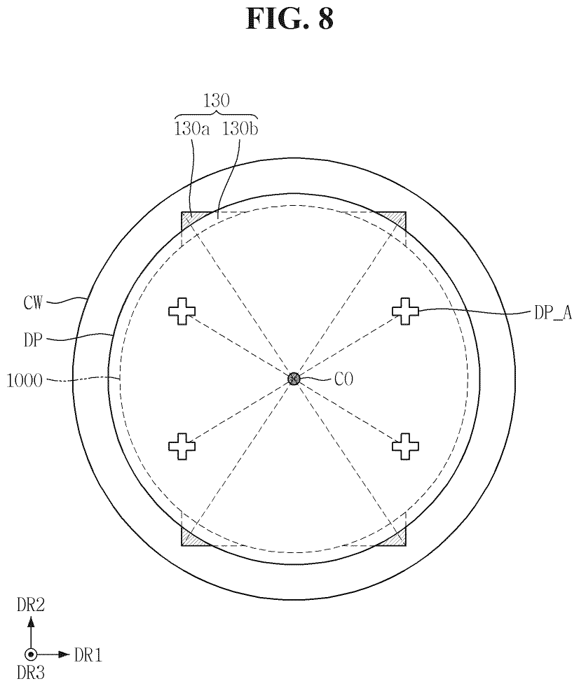

The alignment portion 130 may be disposed on the first fixing portion 120. For example, the alignment portion 130 may be on at least a portion of an outer surface of the first fixing portion 120. The alignment portion 130 may be an alignment mark for aligning the apparatus 1000 for manufacturing a display device with the display panel DP and the cover window during the bonding process. The alignment portion 130 will be described later with reference to FIG. 8.

The stage 200 may provide a space at where the pressing pad 100 may be seated (or accommodated). The stage 200 may be provided with a separate driver to provide a driving force for the pressing pad 100 and a pressing force for pressing the display panel DP and the cover window CW. For example, the stage 200 may provide a driving force to move toward the pressing pad 100 in the third direction DR3.

The stage 200 may be on the opposite side of the display panel DP with the pressing pad 100 interposed therebetween. For example, the stage 200 may be disposed below the pressing pad 100. In the drawing, the stage 200 is illustrated as having a square shape in a plan view but is not limited thereto and may have various suitable shapes.

The stage 200 may include a base 210 and a second fixing portion 220.

The base 210 may constitute a body of the stage 200.

The second fixing portion 220 may be on the base 210. The second fixing portion 220 may fix the pressing pad 100 to the stage 200. The second fixing portion 220 may be coupled to the first fixing portion 120 of the pressing pad 100 to fix the pressing pad 100.

In an embodiment, the second fixing portion 220 may have a groove that is depressed inside the base 210, and the first fixing portion 120 may be inserted into the second fixing portion 220 having the groove shape, but the present disclosure is not limited thereto.

In another embodiment, a groove may be disposed on a lower surface of the first fixing portion 120, the second fixing portion 220 may have a shape that protrudes onto the base 210 in the third direction DR3, and the second fixing portion 220 may also be inserted into the groove of the first fixing portion 120.

In another embodiment, the first fixing portion 120 and the second fixing portion 220 may be coupled in various suitable manners, such as coupling by using electromagnetic force or coupling by using an adhesive member, in addition to physical coupling of the protruding portion and the recessed portion.

In the apparatus 1000 for manufacturing a display device according to the present embodiment, the pressing portion 110 may have a contact surface 111 (e.g., first surface), a side surface 112 (e.g., second surface), and a corner surface 113 (e.g., third surface).

The contact surface 111 of the pressing portion 110 may be an upper surface of the pressing portion 110. For example, the contact surface 111 of the pressing portion 110 may be a surface on the opposite side of a surface at where the pressing portion 110 and the first fixing portion 120 meet. The contact surface 111 of the pressing portion 110 may be in direct contact with the lower surface DP_DS of the display panel DP during the bonding process. The contact surface 111 of the pressing portion 110 may generally extend in the horizontal direction in the first direction DR1 and the second direction DR2.

The contact surface 111 of the pressing portion 110 may be a curved surface. The contact surface 111 of the pressing portion 110 may have a shape that is outwardly convex (e.g., in the third direction DR3). The contact surface 111 of the pressing portion 110 may have a shape that is outwardly convex corresponding to the shape of the upper surface CW_US and lower surface CW_DS of the cover window CW. Accordingly, as described above, the bonding may be performed from the P1 portion to the peripheral portion, thereby reducing or minimizing the bubble formation.

The side surface 112 of the pressing portion 110 may be between the contact surface 111 of the pressing portion 110 and the first fixing portion 120. The side surface 112 of the pressing portion 110 may generally extend in the vertical direction (e.g., in the third direction DR3).

The side surface 112 of the pressing portion 110 may be a curved surface. The side surface 112 of the pressing portion 110 may have an inwardly concave (or depressed) shape. Accordingly, even if the pressing portion 110 having an elastic force expands when pressed, the printed circuit board FPC may not contact the side surface 112 of the pressing portion 110 at the P2 portion, and the occurrence of cracks and defects in the display device DD may be reduced or minimized.

The corner surface 113 of the pressing portion 110 may be between the contact surface 111 and the side surface 112 of the pressing portion 110. The corner surface 113 of the pressing portion 110 may connect the contact surface 111 and the side surface 112 of the pressing portion 110. That is, the contact surface 111, side surface 112, and corner surface 113 of the pressing portion 110 may be physically connected to each other.

The corner surface 113 of the pressing portion 110 may be a curved surface. The corner surface 113 of the pressing portion 110 may have a round curved shape. Accordingly, stress applied to the display panel DP may be reduced or minimized near the boundary surface between the first cover portion CW1 and the second cover portion CW2, such as the P3 portion.

Hereinafter, a design methodology of the contact surface 111, side surface 112, and corner surface 113 of the pressing portion 110 will be described.

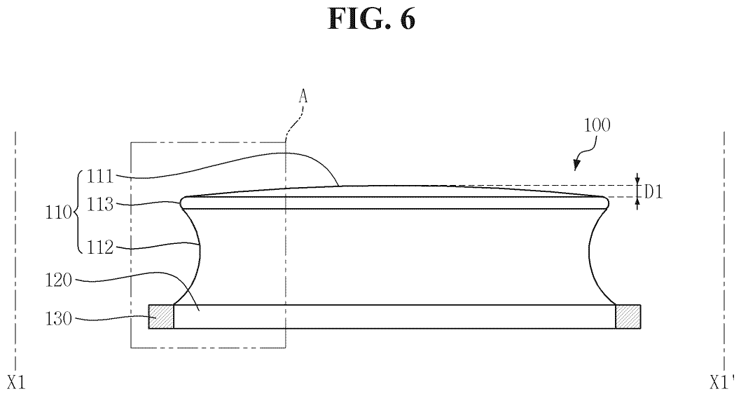

FIG. 6 is a cross-sectional view of the apparatus for manufacturing a display device taken along the line X1-X1′ in FIG. 4. FIG. 7 is an enlarged view of the area A in FIG. 6.

Referring to FIGS. 6 and 7, in addition to FIGS. 2 and 3, the contact surface 111, side surface 112, and corner surface 113 of the pressing portion 110 may each be a circular curved surface. The contact surface 111, side surface 112, and corner surface 113 of the pressing portion 110 may each have a single curvature in a cross-sectional view. Having a single curvature means that the curve or curved surface consists of an arc of a single circle in cross section.

For example, the contact surface 111 of the pressing portion 110 may be a curved surface having a first radius of curvature R1, the side surface 112 of the pressing portion 110 may be a curved surface having a second radius of curvature R2, and the corner surface 113 of the pressing portion 110 may be a curved surface having a third radius of curvature R3. In some embodiments, the first radius of curvature R1 may be greater than the second radius of curvature R2, and the second radius of curvature R2 may be greater than the third radius of curvature R3.

In some embodiments, the contact surface 111 of the pressing portion 110 may be an arc of a first circle whose radius is the first radius of curvature R1, the side surface 112 of the pressing portion 110 may be an arc of a second circle C2 whose radius is the second radius of curvature R2, and the corner surface 113 of the pressing portion 110 may be an arc of a third circle C3 whose radius is the third radius of curvature R3.

In the apparatus 1000 for manufacturing a display device according to an embodiment of the present embodiment, the first radius of curvature R1 of the contact surface 111 of the pressing portion 110 may be smaller than a radius of curvature of the lower surface CW_DS of the cover window CW. In some embodiments, the first radius of curvature R1 of the contact surface 111 of the pressing portion 110 may be approximately 0.5 times or more than the radius of curvature of the lower surface CW_DS of the cover window CW.

TABLE 1

| | 0.4 Times | 0.5 Times | 0.6 Times |
|---|---|---|---|
| Difference in | 0.147 | 0.122 | 0.121 |
| Pressing Force | | | |
| Between Center | | | |
| and Outer Portion | | | |
| (MPa) | | | |

Table 1 above is a table illustrating how the difference in pressing force between the center and the outer portion changes during the bonding process depending on a relative size of the first radius of curvature R1 of the contact surface 111 of the pressing portion 110 with respect to the radius of curvature of the lower surface CW_DS of the cover window CW. Here, the center may refer to the vicinity of the P1 portion shown in FIG. 3, and the outer portion may refer to the vicinity of the P3 portion shown in FIG. 3.

Referring to Table 1 above, when the first radius of curvature R1 of the contact surface 111 of the pressing portion 110 is 0.5 times the radius of curvature of the lower surface CW_DS of the cover window CW, the difference in pressing force between the center and the outer portion may be approximately 0.122 megapascal (MPa). When the first radius of curvature R1 of the contact surface 111 of the pressing portion 110 is 0.6 times the radius of curvature of the lower surface CW_DS of the cover window CW, the difference in pressing force between the center and the outer portion may be approximately 0.121 megapascal (MPa). On the other hand, when the first radius of curvature R1 of the contact surface 111 of the pressing portion 110 is 0.4 times the radius of curvature of the lower surface CW_DS of the cover window CW, the difference in pressing force between the center and the outer portion may rapidly increase to approximately 0.147 megapascal (MPa).

As the difference in pressing force between the center and the outer portion decreases, the occurrence of bubbles at the interface between the cover window CW and the display panel DP may be reduced or minimized. Therefore, in the apparatus 1000 for manufacturing a display device according to the present embodiment, the first radius of curvature R1 of the contact surface 111 of the pressing portion 110 is approximately 0.5 times or more than the radius of curvature of the lower surface CW_DS of the cover window CW, and therefore, the occurrence of bubbles at the interface between the cover window CW and the display panel DP may be reduced or minimized.

In the apparatus 1000 for manufacturing a display device according to the present embodiment, a second distance D2, which is a depression depth of the side surface 112 of the pressing portion 110, may be adjusted by adjusting the second radius of curvature R2.

By adjusting the second radius of curvature R2 and adjusting the second distance D2, which is the depression depth of the side surface 112 of the pressing portion 110, depending on the pressing force applied during the bonding process and the elastic force of the pressing portion 110, contact with the printed circuit board FPC may be prevented.

In addition, in the apparatus 1000 for manufacturing a display device according to the present embodiment, the corner surface 113 of the pressing portion 110 may be formed to be relatively non-sharp by making the side surface 112 of the pressing portion 110 a curved surface with a single curvature.

For example, when the side surface 112 of the pressing portion 110 has a hyperbolic shape, as the second distance D2 becomes deeper, and the corner surface 113 of the pressing portion 110 may be sharply formed. In such an embodiment, stress may be caused in the P3 portion shown in FIG. 3.

On the other hand, in the apparatus 1000 for manufacturing a display device according to the present embodiment, because the side surface 112 of the pressing portion 110 is the arc of the second circle C2 as the curved surface with the single curvature, the corner surface 113 of the pressing portion 110 may be formed to be relatively blunt even if the second distance D2 becomes deeper. Therefore, the stress in the P3 portion shown in FIG. 3 may be reduced or minimized.

In some embodiments, the third circle C3 including the corner surface 113 of the pressing portion 110 as the arc may be in contact with the first circle including the contact surface 111 of the pressing portion 110 as the arc and the second circle C2 including the side surface 112 of the pressing portion 110 as the arc, respectively. For example, the third circle C3 including the corner surface 113 of the pressing portion 110 as the arc may be inscribed in the first circle including the contact surface 111 of the pressing portion 110 as the arc. The third circle C3 including the corner surface 113 of the pressing portion 110 as the arc may be circumscribed about the second circle C2 including the side surface 112 of the pressing portion 110 as the arc.

The contact surface 111 and the corner surface 113 of the pressing portion 110 may be smoothly connected without including an apex or edge. The side surface 112 and the corner surface 113 of the pressing portion 110 may be smoothly connected without including an apex or edge.

Therefore, when the contact surface 111 of the pressing portion 110 is compressed to the inside of the pressing portion 110 and the side surface 112 of the pressing portion 110 is expanded to the outside of the pressing portion 110 due to the pressing force during the bonding process, a change in the shape of the corner surface 113 may be reduced or minimized. Accordingly, the stress in the P3 portion shown in FIG. 3 may be reduced or minimized.

In the apparatus 1000 for manufacturing a display device according to the present embodiment, the depth or degree of protrusion of the corner surface 113 of the pressing portion 110 may be adjusted by adjusting the third radius of curvature R3.

For example, when the third circle C3 including the corner surface 113 of the pressing portion 110 as the arc is in contact with the first circle including the contact surface 111 of the pressing portion 110 as the arc and the second circle C2 including the side surface 112 of the pressing portion 110 as the arc, respectively, the corner surface 113 of the pressing portion 110 may be on the outside as the third radius of curvature R3 decreases, and the corner surface 113 of the pressing portion 110 may be closer to the inside as the third radius of curvature R3 increases.

For example, the number of third circles C3 that are in contact with the first circle and the second circle C2 is infinite, and in the drawing, the third radius of curvature R3 may become smaller toward an upper left end and may become larger toward a lower right end.

As an example, as the third radius of curvature R3 becomes smaller, the third circle C3 moves toward the upper left end of the drawing. Therefore, a third distance D3, which is a horizontal distance at which the corner surface 113 of the pressing portion 110 is inwardly spaced from the outermost side surface of the pressing pad 100, may become smaller, and a first distance D1, which is a vertical distance inwardly spaced from the uppermost surface of the pressing pad 100, may become smaller. Accordingly, because the corner surface 113 of the pressing portion 110 moves further outwardly, the contact area increases, thereby improving bonding performance during the bonding process.

As another example, when the third radius of curvature R3 increases, the third circle C3 moves toward the lower right end of the drawing. Therefore, the third distance D3 may increase and the first distance D1 may increase. Accordingly, the corner surface 113 of the pressing portion 110 moves further inwardly, thereby minimizing stress in the P3 portion shown in FIG. 3.

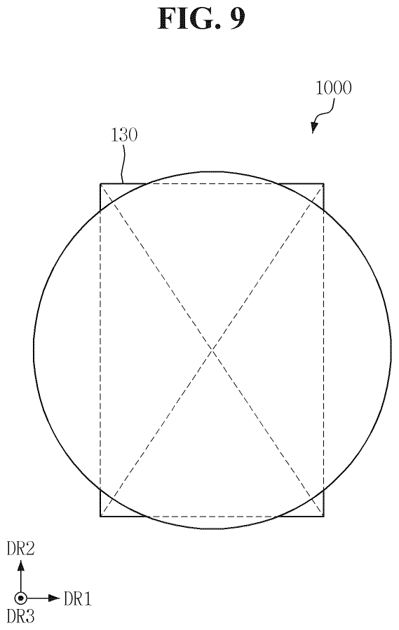

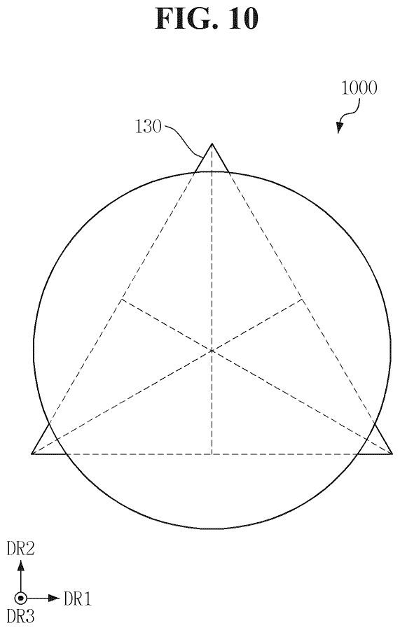

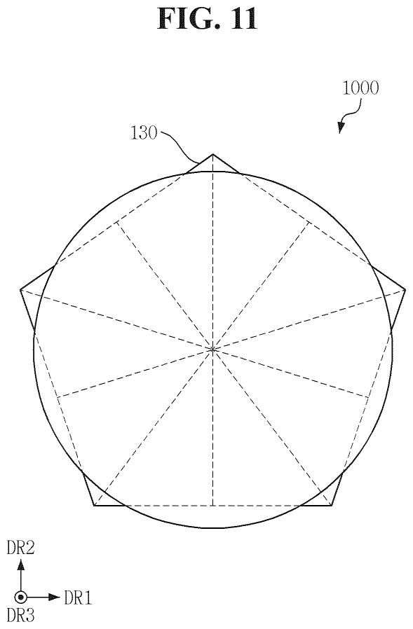

FIG. 8 is a plan view illustrating a process of aligning a cover window, a display panel, and a pressing pad according to an embodiment. FIG. 9 is a plan view illustrating a pressing pad according to an embodiment. FIG. 10 is a plan view illustrating a pressing pad according to another embodiment. FIG. 11 is a plan view illustrating a pressing pad according to another embodiment.

Referring to FIGS. 8 to 11, during the bonding process, the cover window CW, the display panel DP, and the apparatus 1000 for manufacturing a display device may be disposed to overlap each other in the third direction DR3. For example, the cover window CW may be disposed at the top, the display panel DP may be disposed below the cover window CW, and the apparatus 1000 for manufacturing a display device may be disposed below the display panel DP.

Before performing the bonding, an alignment process of aligning the centers of the cover window CW, the display panel DP, and the apparatus 1000 for manufacturing a display device may be performed. For example, the alignment process may be a process of aligning a point of the display panel DP and a point of the apparatus 1000 for manufacturing a display device with the center C0 of the cover window CW.

In some embodiments, the apparatus 1000 for manufacturing a display device may further include a separate vision device. During the alignment process, the vision device may be on the cover window CW.

The display panel DP may include at least one alignment mark DP_A to indicate a point to be aligned with the center C0 of the cover window CW. For example, as illustrated in the drawing, the number of alignment marks DP_A may be four, but the present disclosure is not limited thereto. The number and shape of the alignment marks DP_A may be variously modified.

In some embodiments, a point of the display panel DP aligned with the center C0 of the cover window CW may be an intersection of connection lines of the alignment marks DP_A disposed diagonally, but the present disclosure is not limited thereto.

Because the cover window CW disposed at the top is transparent during the alignment process, the alignment mark DP_A of the display panel DP may be easily visible. On the other hand, because most of the apparatus 1000 for manufacturing a display device disposed below the display panel DP may be covered by the display panel DP, the apparatus 1000 for manufacturing a display device may not be visible from the top.

In some embodiments, to prevent the pressing pad 100 from expanding and contacting the printed circuit board FPC during the bonding process, a size of the apparatus 1000 for manufacturing a display device may be smaller than a size of the display panel DP in a plan view.

The apparatus 1000 for manufacturing a display device according to the present embodiment may improve accuracy of the alignment process by including the alignment portion 130.

The alignment portion 130 may protrude further outwardly than an outer boundary of the display panel DP in a plan view. For example, the alignment portion 130 may include a first portion 130a visible from the top without being covered by the display panel DP during the bonding process, and a second portion 130b covered by the display panel DP.

In an embodiment, as illustrated in FIGS. 8 and 9, the number of alignment portions 130 may be four, but the present disclosure is not limited thereto. In another embodiment, as illustrated in FIG. 10, the number of alignment portions 130 may be three, but in another embodiment, as illustrated in FIG. 11, the number of alignment portions 130 may be five. The number of alignment portions 130 is not limited to those illustrated in the drawings and may be variously modified.

A shape of a figure connecting vertices of each alignment portion 130 may also vary. For example, the shape connecting the vertices of each alignment portion 130 may be a square as illustrated in FIG. 9, may be a triangle as illustrated in FIG. 10, and may be a pentagon as illustrated in FIG. 11. In addition, the shape connecting the vertices of each alignment portion 130 may be a regular polygon as illustrated in FIGS. 10 and 11 and may not be a regular polygon as illustrated in FIG. 9. The shape of the figure connecting the vertices of each alignment portion 130 may be variously modified.

In an embodiment, as illustrated in FIG. 9, when a diagonal intersection of the figure connecting the vertices of each alignment portion 130 may be defined, alignment may be performed by matching the diagonal intersection to the center C0 of the cover window CW.

In another embodiment, as illustrated in FIGS. 10 and 11, when the diagonal intersection of the figure connecting the vertices of each alignment portion 130 is not be defined, alignment may also be performed by drawing a perpendicular line from one vertex to the opposite side and matching the intersection of the perpendicular lines to the center C0 of the cover window CW.

As described above, the apparatus 1000 for manufacturing a display device according to the present embodiment may improve an accuracy of the alignment process by including the alignment portion 130 protruding further outward than the outer boundary of the display panel DP.

Hereinafter, a method for manufacturing a display device according to an embodiment will be described.

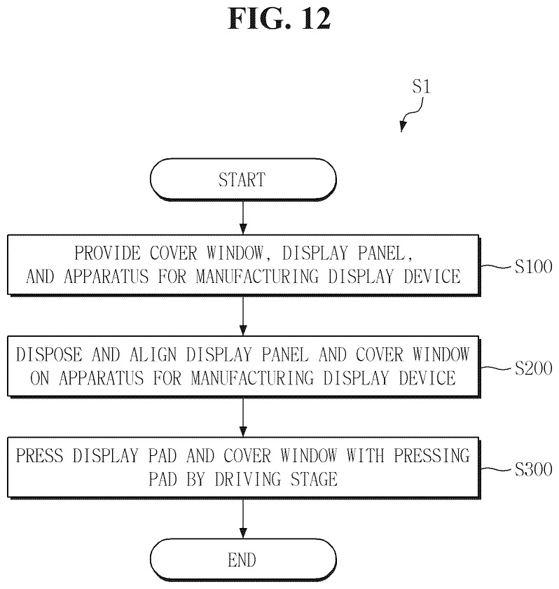

FIG. 12 is a flowchart describing a method for manufacturing a display device according to an embodiment.

Referring to FIG. 12, in addition to FIGS. 1 to 5 and 8, a method S1 for manufacturing a display device according to an embodiment may include providing a cover window, a display panel, and an apparatus for manufacturing a display device (S100), disposing and aligning the display panel and the cover window on the apparatus for manufacturing the display device (S200), and pressing the display panel and the cover window with a pressing pad by driving a stage (S300).

First, a cover window CW, a display panel DP, and an apparatus 1000 for manufacturing a display device are provided (S100).

The descriptions of the cover window CW, the display panel DP, and the apparatus 1000 for manufacturing a display device have been described above and will not be repeated.

Second, the display panel DP and the cover window CW may be disposed and aligned on the apparatus 1000 for manufacturing a display device.

For example, as illustrated in FIG. 2, the display panel DP may be disposed above the apparatus 1000 for manufacturing a display device, and the cover window CW may be disposed above the display panel DP.

As illustrated in FIG. 8, a separate vision device may align the display panel DP with the cover window CW based on the center C0 of the cover window CW by using the alignment mark DP_A of the display panel DP.

In addition, the separate vision device may align the apparatus 1000 for manufacturing a display device with the cover window CW based on the center C0 of the cover window CW using the alignment portion 130 of the apparatus 1000 for manufacturing a display device.

For example, as illustrated in FIG. 8, the alignment portion 130 may include a first portion 130a that protrudes further than an outer portion of the display panel DP, and the separate vision device may confirm whether or not alignment has been achieved by recognizing the protruding first portion 130a.

Third, the apparatus 1000 for manufacturing a display device may press the display panel DP and the cover window CW.

As illustrated in FIGS. 2, 3, and 5, the stage 200 may be driven in the third direction DR3 to provide a driving force to the pressing pad 100. The pressing pad 100 may provide a pressing force to the display panel DP and the cover window CW. Accordingly, the display panel DP and the cover window CW may be bonded to each other.

In concluding the detailed description, those skilled in the art will appreciate that many variations and modifications can be made to the embodiments described herein without substantially departing from the present disclosure. Therefore, the disclosed embodiments of the present disclosure are used in a generic and descriptive sense and not for purposes of limitation.

What is claimed is:

1. An apparatus for manufacturing a display device, the apparatus comprising:
a pressing pad comprising a first fixing portion and a pressing portion on the first fixing portion, the pressing portion comprising:
a first surface on an opposite side with respect to the first fixing portion;
a second surface between the first surface and the first fixing portion; and
a third surface extending between the first surface and the second surface, and
wherein the second surface is a circular curved surface that is inwardly depressed.

2. The apparatus of claim 1, wherein the second surface is an outwardly convex circular curved surface.

3. The apparatus of claim 2, wherein the pressing pad is configured to bond a display panel and a cover window, and
wherein a radius of curvature of the first surface is smaller than a radius of curvature of an inner side surface of the cover window.

4. The apparatus of claim 3, wherein the radius of curvature of the first surface is 0.5 times or more than the radius of curvature of an inner side surface of the cover window.

5. The apparatus of claim 4, wherein the cover window has a three-dimensional shape with curved edges in a cross-sectional view.

6. The apparatus of claim 2, wherein the third surface is an outwardly convex circular curved surface.

7. The apparatus of claim 1, wherein the pressing portion has:
the first surface has an arc that is part of a first circle;
the second surface has an arc that is part of a second circle; and
the third surface has an arc that is part of a third circle, and
wherein the third circle is in contact with each of the first circle and the second circle.

8. The apparatus of claim 7, wherein the third circle is inscribed in the first circle and circumscribed about the second circle.

9. The apparatus of claim 1, wherein the first surface, the second surface, and the third surface each have a single radius of curvature.

10. The apparatus of claim 9, wherein the first surface has a first radius of curvature,
wherein the second surface has a second radius of curvature,
wherein the third surface has a third radius of curvature, and
wherein the first radius of curvature is greater than the second radius of curvature, and the second radius of curvature is greater than the third radius of curvature.

11. The apparatus of claim 1, further comprising a stage configured to provide a space at where the pressing is seated,
wherein the stage comprises a second fixing portion configured to be coupled to the first fixing portion.

12. An apparatus for manufacturing a display device, the apparatus comprising:
a pressing pad comprising a first fixing portion and a pressing portion on the first fixing portion; and
an alignment portion protruding on the first fixing portion,
wherein the alignment portion protrudes further than an outer portion of the first fixing portion and an outer portion of the pressing pad in a plan view.

13. The apparatus of claim 12, wherein the pressing pad is configured to bond a display panel and a cover window, and
wherein the alignment portion protrudes further than an outer portion of the display panel in the plan view.

14. The apparatus of claim 13, wherein the alignment portion comprises a first portion protruding further than the outer portion of the display panel in the plan view and a second portion covered by the display panel.

15. A method for manufacturing a display device by using an apparatus for manufacturing a display device, the apparatus comprising: a pressing pad comprising a first fixing portion and a pressing portion on the first fixing portion, an alignment portion protruding on the first fixing portion, and a stage forming a space at where the pressing pad is seated, the method comprising:
aligning a display panel and a cover window on the apparatus; and
pressing the display panel and the cover window with the pressing pad.

16. The method of claim 15, wherein, in the aligning of the display panel and the cover window, the pressing pad, the display panel, and the cover window are stacked in that order.

17. The method of claim 16, wherein the apparatus further comprises a vision device on the cover window,
wherein the alignment portion protrudes further than an outer portion of the display panel, and
wherein the vision device is configured to recognize the protruding portion of the alignment portion.

18. The method of claim 17, wherein the vision device is configured to align an intersection of diagonal lines connecting the alignment portions arranged diagonally about a center of the cover window.

19. The method of claim 17, wherein the vision device is configured to align an intersection of perpendicular lines between one alignment portion and a side opposite to the one alignment portion about a center of the cover window.

20. The method of claim 15, wherein, in the pressing of the display panel and the cover window, the pressing pad contacts the display panel.
